(19) United States
(12) Patent Application Publication
(10) Pub. No.: US 2021/0081937 A1
(43) Pub. Date: Mar. 18, 2021

(54) ACCESSIBLE USER INTERFACE FOR AUTOMATIC TELLER MACHINE

(71) Applicant: Wells Fargo Bank, N.A., San Francisco, CA (US)

(72) Inventor: Raziq Yaqub, Stewartsville, NJ (US)

(21) Appl. No.: 15/963,788

(22) Filed: Apr. 26, 2018

(51) Int. Cl. G06Q 20/38; G06Q 20/10; G06Q 20/40

(52) U.S. Cl. CPC G06Q 20/3829; G06Q 20/1085; G06Q 20/4012; G06Q 20/40145; G06Q 20/401

(57) ABSTRACT

A method of presenting an accessible user interface relating to one or more account access functions of an automatic teller machine (ATM) by a user computing device is described. The accessible user interface presented by the user computing device for the one or more account access functions of the ATM is different than a user interface presented by the ATM for the same one or more account access functions of the ATM. The method includes receiving data representative of the accessible user interface, presenting the accessible user interface of the ATM, receiving account credentials for a user of the user computing device, authenticating the user of the user computing device based on the account credentials, receiving a selection of an account access function of the one or more account access functions of the ATM, and performing the selected account access function.

### TECHNICAL FIELD

The present disclosure relates to automatic teller machines.

### BACKGROUND

Automatic teller machines (ATMs) provide account holders with a convenient way to perform account access functions. In some examples, a financial institution may provide a number of ATMs at both its retail banking locations and at other remote locations that may be more convenient for account holders such as, for example, office buildings, grocery stores, college campuses, or malls. Additionally, some financial institutions may allow its account holders to perform account access functions using ATMs serviced by other financial institutions, providing an even wider range of locations for the account holder to perform account access functions. In addition to providing more convenient locations, ATMs may also provide account holders with more convenient hours of operation by being available for use during times when a financial institution's retail banking locations are closed, otherwise unavailable, or busy.

### SUMMARY

The disclosure describes devices, systems, and techniques relating to presentation of an accessible user interface of one or more account access functions of an automatic teller machine (ATM) on a user computing device. In some examples, the user computing device may receive data representative of the accessible user interface device relating to one or more account access functions of the ATM and present the accessible user interface on the user computing device. The accessible user interface for the one or more account access functions presented by the user computing device may be different than a user interface presented by the ATM for the same one or more account access functions. In some examples, an accessible user interface may be more user-friendly for a visually impaired user. For example, the accessible user interface may present an account access function of the ATM using an auditory and/or tactile output, while the ATM may present a visual output for the same one or more access functions. By presenting the accessible user interface on the user computing device, the user is able to access an account, authenticate the account, and select an account access function using the accessible user interface on the user computing device rather than relying on the ATM alone. In turn, the user may feel more comfortable or safer performing an account access function, and the transaction may be less time consuming, frustrating, or inconvenient for the user.

In one example, a method includes receiving, by a user computing device and from an automatic teller machine (ATM) associated with a financial institution, data representative of an accessible user interface relating to one or more account access functions of the ATM and presenting, by the user computing device and based on the data, the accessible user interface of the ATM. The accessible user interface presented by the user computing device for the one or more account access functions of the ATM is different than a user interface presented by the ATM for the same one or more account access functions of the ATM. The method further includes receiving, by the ATM via the accessible user interface presented by the user computing device, account credentials for a user of the user computing device; authenticating, by the ATM, the user of the user computing device based on the account credentials; receiving, by the ATM via the accessible user interface presented by the user computing device, a selection of an account access function of the one or more account access functions of the ATM; and performing, by the ATM, the selected account access function.

In another example, a system includes an automatic teller machine (ATM) associated with a financial institution and a user computing device having a communication session with the ATM. The user computing device is configured to receive, from the ATM, data representative of an accessible user interface relating to one or more account access functions of the ATM and present the accessible user interface of the ATM. The accessible user interface presented by the user computing device for the one or more account access functions of the ATM is different than a user interface presented by the ATM for the same one or more account access functions of the ATM. The ATM is configured to receive, via the accessible user interface presented by the user computing device, account credentials for a user of the user computing device, authenticate the user of the user computing device based on the account credentials, receive, via the accessible user interface presented by the user computing device, a selection of an account access function of the one or more account access functions of the ATM, and perform the selected account access function.

In yet another example, a white cane device includes a mobility cane and a user computing device connected to the mobility cane. The user computing device includes a memory and one or more processors. The one or more processors are configured to receive, from an automatic teller machine (ATM), a first set of data representative of a user interface relating to one or more account access functions of the ATM for presentation by the ATM via a visual output and create, based on the first set of data, a second set of data representative of an accessible user interface relating to at least one account access function of the one or more account access functions of the ATM for presentation by the user computing device via at least one of an auditory output or a tactile output. The one or more processors are further configured to present the accessible user interface including the at least one of the auditory output or the tactile output representing the at least one account access function of the one or more account access functions of the ATM; receive a selection of the at least one account access function of the one or more account access functions of the ATM via the accessible user interface; and send, to the ATM, the selection of the at least one account access function.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system that includes a user computing device configured to present an accessible user interface of one or more account access functions of an ATM, in accordance with the techniques of this disclosure.

FIGS. 2A and 2B are conceptual diagrams illustrating example white cane devices configured to support an accessible user interface, in accordance with aspects of the disclosure.

FIG. 3 is a block diagram illustrating an example user computing device configured to present an accessible user interface of one or more account access functions of an ATM, in accordance with the techniques of this disclosure.

FIG. 4 is a block diagram illustrating an example ATM, in accordance with aspects of the disclosure.

FIG. 5 is a flow diagram illustrating an example technique to perform one or more account access functions on an ATM using an accessible user interface presented by a user computing device, in accordance with aspects of the disclosure.

### DETAILED DESCRIPTION

The disclosure describes devices, systems, and techniques relating to presentation of an accessible user interface for one or more account access functions of an automatic teller machine (ATM) on a user computing device. The accessible user interface for the one or more account access functions presented by the user computing device may be different than a user interface presented by the ATM for the same one or more account access functions. For instance, the accessible user interface may present the one or more account access functions using an auditory and/or a tactile output and the ATM may use a visual output to present the same one or more account access functions. Presenting the accessible user interface on the user computing device enables the user to access an account, authenticate the account, and select an account access function using the accessible user interface on the user computing device rather than relying on the user interface presented by the ATM, which may not be accessible for a visually impaired person or may be relatively difficult to use for a visually impaired person. In this way, the user may feel more comfortable or safer performing an account access function via an ATM through the use of his or her own user computing device. In some examples, the devices, system, and techniques described herein use a three-level authentication process, which may additionally make the user feel safer and/or more comfortable while performing the account access function. Moreover, the transaction may be less time consuming, frustrating, and/or inconvenient for the user. The devices, systems, and techniques described herein also enable a user computing device to present a user interface for interaction with an ATM that is different than the user interface presented by the ATM itself.

In some examples, an ATM may be difficult or inconvenient to use for a visually impaired user. For example, some ATMs may present visual instructions, present visual options, rely on a user's sight to determine the layout of the ATM, such as the location of a keypad or other input interface, or the like. Thus, in some cases, an ATM may include an accessible mode for a visually impaired user in addition to, or as an alternative to, the visual functionality of the ATM. For example, an ATM may include an output interface, such as a headphone jack, in which a user can connect headphones or another output device. In some such cases, the connection of headphones or another output device may automatically switch the ATM into an accessibility mode in which information such as instructions, a layout of the ATM, transaction options, or the like are presented to the user audibly.

However, different ATMs may have different layouts. For example, an ATM of one financial institution may have an output interface in a first location, and an ATM of a different financial institution may have an output interface in a second location different from the first location. Additionally, in some cases, ATMs of the same financial institutions may have output interfaces in varying locations. In this way, a visually impaired user may need to search for the output interface to enable the accessible mode each time he or she needs to use an ATM, which may be difficult, time consuming, and/or frustrating for the user. In a similar manner, the location of a cash dispenser, a keypad, or other components of different ATMs may be located in varying locations.

Additionally, or alternatively, not all ATMs may include an output interface and/or an accessible mode. In some such examples, a visually impaired user may spend time searching for output interface only to find that an ATM does not include one. In turn, the user may have to locate a different ATM to perform an account access function or may have to complete the account access function through an in-person teller. In some cases, an in-person teller may have less convenient locations or hours of operation, wait times, or the like.

Moreover, in some examples, a visually impaired user may be more likely to be subject to fraud and/or theft when using an ATM in comparison to a non-visually impaired user. For example, a visually impaired user may not be able to inspect the ATM for a skimming device, a cash trapping device, or the like. In addition, a bad actor may be able to more easily steal funds dispensed by the ATM. For instance, a bad actor may be able to find a cash dispenser of the ATM and take funds dispensed for a withdrawal transaction before the visually impaired user is able to find the cash dispenser and take the dispensed funds themselves.

In some examples, an ATM may be configured to exchange information with a user computing device to mirror a user interface presented by the ATM on the user computing device. For instance, the ATM may send the user computing device data relating to one or more functions of the ATM for presentation on the user computing device in the same format as is presented by the ATM itself. In this way, the user interface mirrored on the user computing device may be the same as the user interface presented by the ATM, and the user computing device may not have any way of presenting an accessible user interface. In turn, such mirrored user interfaces may still be difficult, time consuming, and/or frustrating for a visually impaired user for a visually impaired user.

The devices, systems, and techniques described herein enable a user, such as a visually impaired user, to perform one or more account access functions of an ATM using an accessible user interface presented by a user computing device. The user may be more accustomed to the user computing device which may prevent the user from having to search for an output interface device and/or needing to perform the account access function using an in-person teller. In addition, the use of an accessible interface on the user computing device may allow the user to perform faster, safer, and/or more convenient account access functions in comparison to using some ATMs or in-person tellers to perform such account access functions. In addition, in some examples, the devices, systems, and techniques described herein may use a three-level authentication process, further improving the safety and/or security of performing the account access function. Moreover, the devices, systems, and techniques described herein enable a user computing device to present an accessible user interface for interaction with an ATM that is different than a user interface presented by the ATM itself. The accessible user interface may be designed or modified for the processing capabilities of the user computing device such that the user computing device may require less processing time, power consumption, data modification, or the like to present the accessible user interface compared to mirroring the same user interface as presented by the ATM itself.

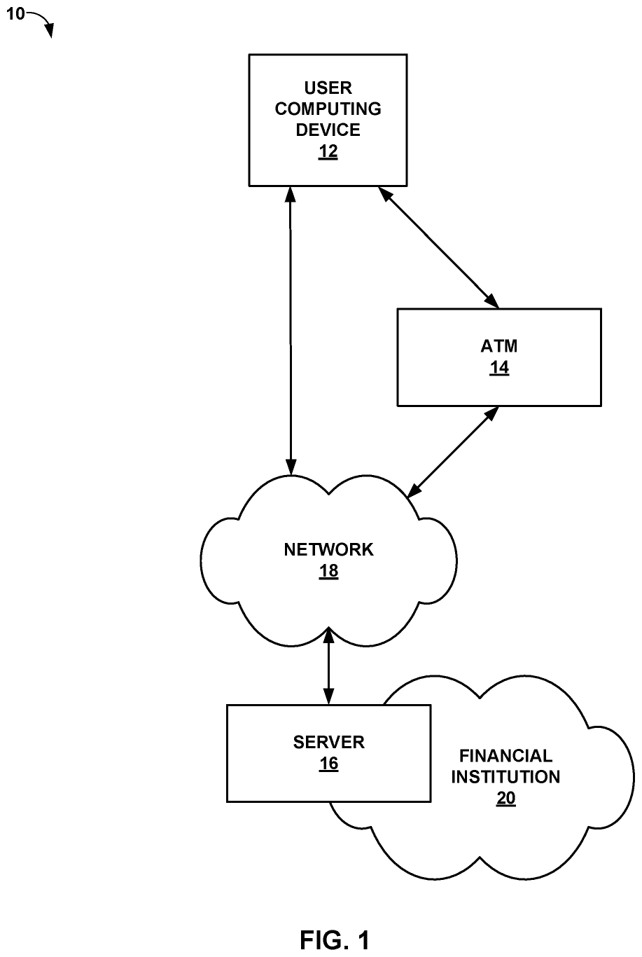

FIG. 1 is a block diagram illustrating an example system 10 that includes a user computing device 12 configured to present an accessible user interface of one or more account access functions of an ATM 14, in accordance with the techniques of this disclosure. As shown in the example of FIG. 1, ATM 14 is in communication with a server 16 of a financial institution 20 via network 18. In some examples, network 18 may be a private network or a public network, such as the Internet. Although illustrated as a single entity, network 18 may include a combination of two or more public and/or private networks. Network 18 may include one or more of a wide area network (WAN) (e.g., the Internet), a local area network (LAN), a virtual private network (VPN), or another wired or wireless communication network. In some examples, network 18 may be a service provider network coupled to one or more networks administered by other providers, and may thus form part of a large-scale public network infrastructure, e.g., the Internet. Server 16 may be owned and/or operated by financial institution 20.

Although network 18 is illustrated in FIG. 1 as facilitating communication between ATM 14 and server 16 with computing device 12 only accessing network 18 via ATM 14, in some examples, user computing device 12 may also be configured to directly access network 18. For example, user computing device 12 may be configured to exchange information directly with server 16 via network 18 such that user computing device 12 and server 16 do not necessarily have to communicate through ATM 14.

Financial institution 20 may be a traditional bank or credit union with the capability to maintain user accounts. For example, financial institution 20 may maintain checking, savings, and/or investment accounts for account holders. Financial institution 20 may issue ATM access to accounts within financial institution 20 and/or accounts at other institutions. In other cases, financial institution 20 may be a third-party for storing information for one or more traditional banks or credit unions but may not necessarily maintain any user accounts within financial institution 20.

As illustrated in the example of FIG. 1, server 16 is associated with financial institution 20. The functionality of server 16 may be implemented in hardware or in a combination of software and hardware, where requisite hardware may be provided to store and execute software instructions. While shown as a single computing device in the example of FIG. 1 for purposes of illustration, in some examples, server 16 may include a distributed network of computing devices including one or more workstations, servers, and/or other computing devices within financial institution 20.

Server 16 may authenticate users of ATM 14 and/or user computing device 12 based on login credentials, e.g., an account number, a personal identification number (PIN), biometric information, or other user identifiers, entered at ATM 14 and/or user computing device 12. After authentication, server 16 may access information related to the accounts of the authenticated users held at the financial institution to perform account access functions requested by the users via ATM 14 and/or user computing device 12. For example, server 16 may perform financial transactions including one or more of withdrawal transactions, fund deposits, fund transfers, or account balance checks. In addition, in some cases, server 16 may re-authenticate a user based on biometric information obtained by ATM 14 and or user computing device 12 prior to performing certain financial transactions, e.g., withdrawal transactions.

ATM 14 may be a device used to perform a variety of account access functions, such as, for example, financial transactions including one or more of withdrawal transactions, fund deposits, fund transfers, or account balance checks. ATM 14 may include a display for displaying information and/or receiving inputs. Alternatively, or additionally, ATM 14 may include a keypad or other input device for receiving inputs. Such input devices enable a user to access an account, authenticate an account, and/or select an account access function to be performed by ATM 14.

ATM 14 may include components for vending or accepting cash and/or checks for various transactions including, for example, conventional deposits or withdrawals, exchange of local currency for foreign currency or vice versa, and/or withdrawal of foreign currency. ATM 14 may include a printer component for printing documents for various transactions including, for example, receipts for deposits, receipts for withdrawals, receipts for purchases, or the like. ATM 14 may include a component to dispense envelopes. ATM 14 may also include a component to dispense cash and/or a component to dispense cash within an envelope.

The components of ATM 14 described herein may be separate components, each dedicated to a separate function, or may be combined in any suitable number of components to perform the functions described herein. A single component may include different subcomponents used for performing different tasks or may use the same subcomponents for each task according to particular needs.

In addition to accessing an account, authenticating an account, and/or selecting an account access function using the components of ATM 14, ATM 14 is configured to communicate with user computing device 12 such that a user may use user computing device 12 to access an account, authenticate an account, and/or select an account access function to be performed by ATM 14. In this way, a user is able to use an accessible user interface presented by his or her personal user computing device 12 to access an account, authenticate an account, and/or select an account access function rather than relying on ATM 14 itself. For instance, the user may be a visually impaired user that is more comfortable using and more familiar with user computing device 12, an output interface on ATM 14 may be difficult for the user to find, ATM 14 may not include an output interface, or the like. Thus, instead of spending time searching for an output interface device or having to use an in-person teller, the user can use the accessible user interface presented by user computing device 12 to operate ATM 14.

The accessible user interface for one or more account access functions presented by user computing device 12 may be different than a user interface presented by ATM 14 for the same one or more account access functions. For example, ATM 14 may present a visual output representing the one or more account access functions and user computing device 12 may present at least one of an auditory output or a tactile output representing the same one or more account access functions. In some examples, the auditory output may include a speech output and the tactile output may be a haptic output. In this way, user computing device 12 presents an accessible user interface that may be easier to use for a visually impaired user in comparison to a visual user interface presented by ATM 14.

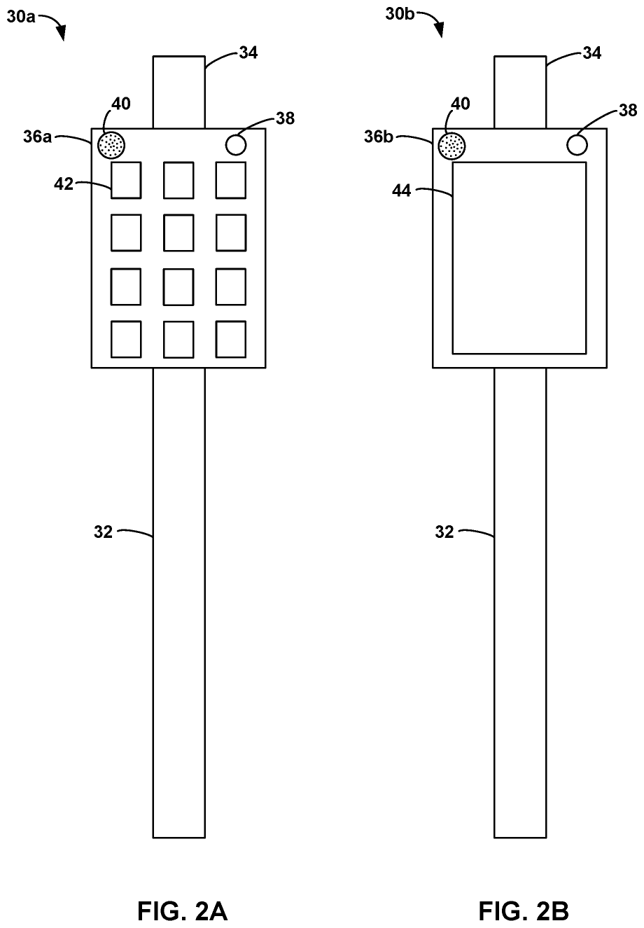

User computing device 12 may include any of a wide range of user devices, including laptop or desktop computers, tablet computers, so-called “smart” phones, “smart” pads, or other personal digital appliances equipped for wired or wireless communication. In some examples, user computing device 12 includes a white cane device configured to support the accessible user interface as described herein. For example, user computing device 12 may be a user device connected to a probing cane (e.g., a cane used as a mobility tool for a visually impaired user) or a “smart” probing cane. Examples of white cane devices configured to support the accessible user interface will be described in more detail with respect to FIGS. 2A and 2B.

User computing device 12 may include one or more output interfaces and one or more input interfaces. For example, user computing device 12 may include one or more output interfaces including at least one of a speaker, a headphone jack, a vibration motor, or an actuator. Additionally, or alternatively, user computing device 12 may be able to connect to an output device using a communication protocol such as Bluetooth®. For instance, user computing device 12 may be able to connect to Bluetooth® enabled headphones. In turn, user computing device 12 may be able to provide feedback, instructions, or the like to the user. For example, user computing device 12 may provide feedback indicating a selection made by the user, confirmation of a connection to ATM 14, confirmation of an authentication step, or the like. Additionally, or alternatively, user computing device 12 may provide instructions to the user, such as, for example, instructions regarding the layout of ATM 14 to help the user more easily find a cash dispenser or another component of ATM 14.

User computing device 12 may include one or more input interfaces including at least one of a keypad, a touch screen, or a microphone, enabling the user to input information or selections using user computing device 12. In some cases, user computing device 12 may also include an input interface device configured to send a silent alarm. For example, a user may feel threated and select an input interface device including an emergency button and a silent alarm may be sent to an authority through user computing device 12 and/or ATM 14. In some examples, user computing device 12 may also include brail on and/or around the input or output interfaces.

The user may be accustomed to user computing device 12 (e.g., the user may be relatively familiar with the layout of the one or more input and output interfaces of user computing device 12). Thus, utilization of user computing device 12 to access an account, authenticate the account, and/or select one or more account access functions, as well as the feedback provided by user computing device 12, may be easier, less frustrating, more convenient, and/or more comfortable for a user, especially a visually impaired user, in comparison to the user completing an account access function using ATM 14 alone.

In some cases, user computing device 12 includes an application that enables user computing device 12 to establish a communication session with ATM 14, send information to ATM 14, receive information from ATM 14, and/or present an accessible user interface. In some such examples, user computing device 12 may not connect to ATM 14 as described herein without the application. For example, the application may include a mobile banking application that is capable of presenting the accessible user interface on user computing device 12 in a different form than is presented by ATM 14 itself. In this way, the application enables the user to interact with ATM 14 (e.g., perform one or more account access functions) using the accessible user interface presented on user computing device 12. The application may also help establish a communication session between user computing device 12 and ATM 14. Additionally, or alternatively, in some examples, the application may provide information and/or credentials for authentication of the user and/or user computing device 12 to ATM 14.

In some examples, system 10 may use a three-level authentication scheme in accordance with the techniques described herein. In a first level of authentication, ATM 14 may establish a communication session between ATM 14 and user computing device 12 such that user computing device 12 and ATM 14 can exchange messages securely. ATM 14 and user computing device 12 may communicate via any communication protocol. In some examples, a communication channel between ATM 14 and user computing device 12 may have a relatively short range, such as a personal area network (PAN). For example, ATM 14 and user computing device 12 may establish a communication session via Bluetooth®, ZigBee, a wireless Universal Serial Bus (USB), Infrared Data Association (IrDA), transmission control protocol/internet protocol (TCP/IP), near field communication (NFC), radio frequency identification (RFID), or the like. In other examples, other wireless technologies, such as Wi-Fi, Wi-Fi direct, or the like, may be used establish a communication session between ATM 14 and user computing device 12.

In some cases, communication between ATM 14 and user computing device 12 may use a secure communication channel so that a bad actor cannot intercept sensitive financial information when the user is utilizing the accessible user interface on user computing device 12 to exchange sensitive financial information with ATM 14. For example, data and information sent between ATM 14 and user computing device 12 may be encrypted. In some such examples, ATM 14 and user computing device 12 may establish a public key infrastructure (PKI) secure communication session over a network, such as a PAN or a WAN, e.g., network 18. Additionally, or alternatively, ATM 14 and user computing device 12 may exchange a symmetric session key to encrypt the data and information sent between ATM 14 and user computing device 12 during the established communication session.

In some cases, server 16 may be involved in establishing the PKI secure communication session and/or selection of the symmetric session key. For example, server 16 may facilitate the assignment of digital certificates to user computing device 12 and ATM 14 for the PKI secure communication session, and assign the session key to at least one of ATM 14 or user computing device 12.

In some examples, user computing device 12 may initiate a communication session between user computing device 12 and ATM 14. For example, a user may access the application in the presence of ATM 14, which may enable communication between user computing device 12 and ATM 14. Additionally, or alternatively, ATM 14 may be configured to detect user computing device 12 when user computing device 12 is within a predetermined range from ATM 14. For example, ATM 14 may detect that user computing device 12 is within a predetermined range of about 10 feet, about 5 feet, or about 1 foot from ATM 14. In some examples, detection of user computing device 12 within the predetermined range from ATM 14 may initiate a communication session being established between user computing device 12 and ATM 14.

In some examples, ATM 14 and user computing device 12 may exchange information to determine communication capabilities of the other of ATM 14 and/or user computing device 12. ATM 14 and user computing device 12 may be connected using one of the identified communication capabilities. For example, ATM 14 may have Bluetooth® capabilities and may determine if user computing device 12 also has Bluetooth® capabilities. If ATM 14 determines that user computing device 12 does have Bluetooth® capabilities, ATM 14 may establish the communication session with user computing device 12 using Bluetooth® and push data representative of an accessible user interface to user computing device 12. The accessible user interface may relate to one or more account access functions of ATM 14. In this way, user computing device 12 and ATM 14 may establish a communication session by a user accessing the application on user computing device 12 and/or user computing device 12 being within a predetermined range of ATM 14, without requiring any additional steps or involving server 16.

In other examples, ATM 14 may receive a limited amount of information from user computing device 12 upon initiation of the application on user computing device 12 or detection of user computing device 12 by ATM 14. For example, ATM 14 may obtain a unique identifier of user computing device 12 and may send the unique identifier to server 16 for authentication. Server 16 may compare the received unique identifier to a unique identifier stored in server 16 and associated with user computing device 12. For example, upon download and/or installation of the application on user computing device 12, user computing device 12 may communicate with server 16, and server 16 may associate a unique identifier with user computing device 12, which may register user computing device 12 with financial institution 20. In some examples, the unique identifier may be based on a media access control (MAC) address of user computing device 12, an account number of the user, or both. In other examples, the unique identifier may be based on something other than the MAC address of user computing device 12 and/or the account number of the user.

If the unique identifier obtained by ATM 14 and the unique identifier stored in server 16 and associated with user computing device 12 are the same, then a communication session between ATM 14 and user computing device 12 can be established. If the unique identifier obtained by ATM 14 and the unique identifier stored in server 16 and associated with user computing device 12 are not the same or if user computing device 12 does not have a unique identifier associated with it in server 16, then communication between ATM 14 and user computing device 12 may be terminated. In this way, establishment of the communication session using authentication of the unique identifier may be more secure than establishment of a communication session without first authenticating the unique identifier obtained from user computing device 12. For example, in this case, ATM 14 verifies that user computing device 12 is interested in communication with ATM 14 (e.g., based on user computing device 12 being a user computing device registered with financial institution 20) prior to the exchange of sensitive financial information between ATM 14 and user computing device 12.

Additionally, or alternatively, a user may obtain a one time passcode and/or a passcode card from financial institution 20 that enables the user to register with one or more ATMs of financial institution 20 to establish a communication session between user computing device 12 and ATM 14 for a first time. For example, user computing device 12 may receive the one time passcode from server 16 upon downloading and installing the application on user computing device 12. ATM 14 may detect user computing device 12 within a predetermined distance from ATM 14 and attempt to establish a communication session with user computing device 12. In some examples, if user computing device 12 and ATM 14 are attempting to establish a communication session for a first time, a user may input the one time passcode using ATM 14 and/or user computing device 12 to establish the communication session. In addition, or as an alternative, the user may have received a passcode card from financial institution 20 and may have to insert and/or swipe the passcode card using user computing device 12 and/or ATM 14. In some cases, the user may have to input the one time passcode or insert and/or swipe the passcode card using ATM 14 to connect ATM 14 and user computing device 12 for a first time. ATM 14 may receive the one time passcode and/or passcode card information (e.g., input into ATM 14 or received from user computing device 12) and may send the one time passcode or passcode card information to server 16 for authentication. For example, server 16 may include the one time passcode and/or passcode card information associated with user computing device 12, which may indicate that user computing device 12 is registered with financial institution 20.

As yet another example, ATM 14 may have facial recognition capabilities, and may identify the user based on facial recognition. For example, server 16 may include facial recognition data of the user associated with user computing device 12, and ATM 14 may send obtained facial recognition data of the user to server 16 for authentication. In some examples, the unique identifier, one time passcode, passcode card information, and/or facial recognition data may be considered registration information that may indicates that user computing device 12 is interested in communication with ATM 14 (e.g., based on user computing device 12 being a user computing device registered with financial institution 20). The registration information may be compared to stored registration information (e.g., a unique identifier, one time passcode, passcode card information, and/or facial recognition stored at server 16) associated with user computing device 12 prior to the exchange of sensitive financial information between ATM 14 and user computing device 12.

In some examples, user computing device 12 and an ATM not associated with financial institution 20 (e.g., an ATM associated with a different financial institution) may attempt to establish a communication session in accordance with the techniques described herein. In some such examples, in the case in which the registration information is used to authenticate the communication between user computing device 12 and the ATM, a server associated with the financial institution associated with the ATM may not include the registration information associated with user computing device 12. Thus, in some cases, the server associated with the ATM may pass the received registration information to server 16 (or another server associated with financial institution 20) for authentication.

In some examples, upon establishing the communication session with ATM 14, user computing device 12 may present a welcome message and/or prompt the user to input consent to operate ATM 14 through the accessible user interface presented by user computing device 12. Moreover, user computing device 12 may provide feedback to the user to indicate the establishment of the communication session, such as, for example, auditory or tactile feedback.

In some cases, after the initial communication session is established between ATM 14 and user computing device 12, ATM 14 may remember user computing device 12 and may not have to verify user computing device 12 each time user computing device 12 attempts to establish communication with ATM 14. For example, ATM 14 may store the registration information locally, compare the received registration information to the locally stored registration information and establish a communication session with user computing device 12 based on the comparison. As another example, user computing device 12 may not present a welcome message and/or require input of consent by the user after user computing device 12 and ATM 14 have established a communication session one or more times. In this way, user computing device 12 and ATM 14 that previously established a communication session may automatically connect and establish a communication session, such as when user computing device 12 is within a predetermined range from ATM 14. In some such examples, ATM 14 and/or user computing device 12 may use caching, machine learning, or the like to simplify future transactions performed via the accessible user interface presented by user computing device 12. In other examples, ATM 14 may verify user computing device 12 with server 16 each time user computing device attempts to connect to ATM 14.

In some cases, one or more other ATMs associated with financial institution 20 may not need to verify user computing device 12 after user computing device 12 has been verified by a first ATM 14 associated with financial institution 20. In other cases, user computing device 14 may be verified for each ATM to which user computing device 12 has not previously connected.

Additionally, or alternatively, ATM 14 may detect that user computing device 12 is within the predetermined range of ATM 14 and may authenticate that user computing device 12 is registered with financial institution 20. For example, ATM 14 may remember user computing device 12 or verify that user computing device 12 is registered with financial institution 20 using server 16. In some such examples, ATM 14 and/or server 16 may be able to determine whether user computing device 12 is a white cane device configured to support the accessible user interface of ATM 14. If ATM 14 or server 16 determines that user interface device 12 is a white cane device, ATM 14 may send the data representative of the accessible user interface relating to the one or more account access functions of ATM 14 to user computing device 12. For example, determination that user computing device 12 is a white cane device may indicate that the user is a visually impaired user that may want to operate ATM 14 using the accessible user interface presented by user computing device 12. In this way, ATM 14 automatically sending user computing device 12 the data representative of the accessible user interface may require less input or steps to be taken by the user.

Once a communication session has been established between ATM 14 and user computing device 12, user computing device 12 may receive data representative of an accessible user interface relating to one or more account access functions of ATM 14 from ATM 14. For example, ATM 14 may create the data representative of the accessible user interface based on data representative of a user interface presented by ATM 14 for the same one or more account access functions. As described above, the data representative of the accessible user interface relating to the one or more account access functions of ATM 14 may include data representative of an auditory output, a tactile output, or both for the one or more account access functions. In this way, the data representative of the one or more account access functions of ATM 14 may not need to include data representative of a visual output of the one or more account access functions of ATM 14.

As another example, ATM 14 may store data representative of the accessible user interface and may not need to create the data representative of the accessible user interface based on the user interface presented by ATM 14. For example, in some cases, ATM 14 may include an accessible mode which can be accessed upon a user connecting an output device to ATM 14, and the data used for the accessible mode may also be able to be sent to user computing device 12 for presentation as an accessible user interface on user computing device 12. In this way, the functionality of ATM 14 described herein may be able to be added to or retrofit on existing ATMs without having to create new data representative of the accessible user interface.

Additionally, or alternatively, user computing device 12 may receive a first set of data representative of a user interface presented by ATM 14 for one or more account access functions of ATM 14, and user computing device 12 may create a second set of data based on the first set of data that represents an accessible user interface of the same one or more account access functions of ATM 14. For example, the first set of data representative of the user interface presented by ATM 14 may include data representative of a visual output of the one or more account access functions, and user computing device 12 may create the second set of data including data representative of an auditory and/or tactile output of the same one or more account access functions based on the first set of data. In other examples, user computing device 12 may make modifications to the data received from ATM 14 so that the accessible user interface can be presented by user computing device 12.

In any case, the accessible user interface may be different than the user interface presented by ATM 14 for the same one or more account access functions. For example, the accessible user interface may include user computing device 12 presenting at least one of auditory or tactile output, such as speech or haptic output, representing the one or more account access functions, and the user interface presented by ATM 14 representing the same one or more account access functions may include a visual output. User computing device 12 presents the accessible user interface based on the data representative of the accessible user interface. Thus, in the case of a visually impaired user, the accessible user interface presented by user computing device 12 may enable the visually impaired user to more easily and/or comfortably perform one or more account access functions in comparison to using ATM 14 alone.

In some examples, ATM 14 may be configured to determine processing capabilities of user computing device 12. For example, upon determining communication capabilities of user computing device 12 and/or establishing a communication session with user computing device 12, ATM 14 may also determine the processing capabilities of user computing device 12. In some cases, ATM 14 may send data representative of the accessible user interface to user computing device 12 based on the processing capabilities of user computing device 12. For instance, ATM 14 may include different sets of data representative of accessible user interfaces for different processing capabilities of user computing device 12. In some such examples, ATM 14 may have different sets of data representative of accessible user interfaces based on an operating system, battery power, memory capacity, input interfaces, output interfaces, or the like of user computing device 12. In this way, user computing device 12 may require less processing time, power consumption, data modification, or the like to present the accessible user interface designed or modified for the processing capabilities of user computing device 12.

In a second level of authentication, the user's account credentials are authenticated. ATM 14 receives the account credentials for the user via the accessible user interface of the ATM presented on user computing device 12. The account credentials may include both an account number and a PIN. In some examples, user computing device 12 may store the user's account number and may send the account number to ATM 14. In some such examples, user computing device 12 may include a button or other input interface in which the user can select to send the account number to ATM 14. As another example, upon establishing a communication channel with ATM 14, user computing device 12 may automatically send the user's account number to ATM 14. In yet another example, a user may be able to swipe or insert a card containing the account number using user computing device 12. As an additional example, user computing device 12 may include a NFC reader (or another close-range reader) configured to obtain the account number from a card held or moved near user computing device 12. Moreover, the user may be able to insert or swipe a card including the account number on ATM 14 itself. In any case, user computing device 12 may prompt the user to input a PIN associated with the account number for two-part authentication. In this way, even if user computing device 12 was stolen and/or misplaced, a bad actor could not access the user's account without also knowing the PIN associated with the account number.

User computing device 12 may provide feedback acknowledging the sent account number or PIN, what was input for the PIN (e.g., user computing device 12 may audibly indicate numbers or letters entered as the PIN), receipt of the account credentials by ATM 14, successful authentication of the account credentials, or the like. User computing device 12 may provide such feedback either by auditory or tactile output, such as a speech output or a haptic output.

ATM 14 may receive the account credentials including the account number and the PIN and authenticate the user based on the account credentials. As one example, ATM 14 may send the account credentials to server 16 for authentication that the received account number and PIN are correct. For instance, server 16 may compare the received PIN to a stored PIN associated with the account number of the user. As another example, ATM 14 may compare the received PIN to a stored PIN associated with the received account number of the user and verify the PIN based on the comparison.

After the user's account credentials are authenticated, the user may be able to select an account access function using the accessible user interface on user computing device 12. An account access function may include a withdrawal transaction, a fund deposit, a fund transfer, an account balance check, or another function related to the financial account of the user. Selection of the account access function may include selection of the specific account access function itself, as well as one or more inputs associated with the selected account access function. As one example, the user may input an amount to be withdrawn or deposited using the one or more input interfaces of user computing device 12. In some examples, user computing device 12 enables the user to select more than one account access function, either at the same time or after a first account access function has been performed by ATM 14. User computing device 12 receives the selection from the user via the accessible user interface of at least one account access function and sends the selection of the at least one account access function to ATM 14. ATM 14 receives the selection of the account access function from user computing device 12.

User computing device 12 may provide feedback based on the selection of the at least one account access function. For example, user computing device 12 may present an auditory and/or tactile output indicating a status of the account access function to be performed, instructions, confirmation of the selection, or the like.

In examples in which the selected account access function includes a withdrawal transaction, ATM 14 may require a third level of authentication of the user. In some such examples, ATM 14 may include one or more biometric devices. For example, ATM 14 may include one or more fingerprint scanners, retina scanners, facial recognition devices, or other biometric devices. As one example, ATM 14 may include one or more fingerprint scanners around a cash dispenser of the ATM 14. If ATM 14 receives a selection of a withdrawal transaction, ATM 14 may alert user computing device 12 to prompt the user to prepare for ATM 14 to obtain biometric information. For example, user computing device 12 may instruct the user to place his or her fingers on an edge surrounding the cash dispenser (e.g., an upper edge and/or a lower edge of an opening or mechanical shutter of the cash dispenser) where one or more fingerprint scanners may be located on ATM 14. In some examples, user computing device 12 may further direct the user to the edge by describing the layout of ATM 14 to the user, such as through the use of auditory instructions and/or vibratory cues.

In some cases, ATM 14 may not dispense the funds for the withdrawal transaction until after ATM 14 has obtained and authenticated the biometric information of the user. In some examples, ATM 14 may send the biometric information of the user to server 16 to re-authenticate the user based on the biometric information. For instance, server 16 may compare the received biometric information to biometric information associated with the user's account credentials, a unique identifier of user computing device 12, or other identifying information of the user or user computing device 12. If the received biometric information and the stored biometric information are the same, ATM 14 may dispense the funds for the withdrawal transaction. In some cases, the user may have to maintain contact with the biometric input device until the funds are dispensed such that a bad actor cannot intercept the funds after the user has been re-authenticated using the biometric information. In this way, a bad actor may be less likely to steal from or otherwise compromise the user. In some examples, visually impaired users may be more susceptible to theft and/or fraud, and the three-level authentication of system 10 described herein may help prevent such theft and/or fraud.

In some examples, account access functions other than withdrawal transactions may be additionally or alternatively undergo the third level of authentication to re-authenticate the user. As one example, ATM 14 may obtain biometric information of the user for re-authentication upon the selection of an account balance check.

In some cases, server 16 may obtain the biometric information from user computing device 12 upon registration of user computing device 12 with financial institution 20 as described herein. For example, user computing device 12 may be configured to obtain and send biometric information to server 16 upon download and/or installation of the application configured to enable the techniques of this disclosure on user computing device 12. As another example, ATM 14 and/or user computing device 12 may be configured to obtain and send biometric information of the user to server 16 upon establishing a first communication session between ATM 14 and user computing device 12.

User computing device 12 may present additional options, provide feedback, or the like using an output interface device. For example, after completion of an account access function, user computing device 12 may prompt the user if he or she would like a receipt, provide a speech output of a receipt, ask if the user would like to perform any additional account access functions, play a thank you message, or the like.

In some examples, ATM 14 and/or user computing device 12 may automatically terminate the communication session upon completion of an account access function, after a thank you message has been played, or the like. In this way, ATM 14 and user computing device 12 may only have a communication session established to present the accessible user interface on user computing device to operate ATM 14 and the communication session may be terminated once the user is finished using ATM 14 via the accessible user interface, which may reduce the likelihood of a bad actor intercepting sensitive financial information of the user.

FIGS. 2A and 2B are conceptual diagrams illustrating example white cane devices 30a, 30b configured to support an accessible user interface, in accordance with aspects of the disclosure. White cane devices 30a, 30b include a mobility cane 32 and a user computing device 36a, 36b. In some examples, mobility cane 32 includes a handle 34. Mobility cane 32 may include a long cane, a guide cane, an identification cane, a support cane, a green cane, or any other cane or probing device that may indicate a user is visually impaired and/or act as a mobility device for a visually impaired user.

In some examples, white cane device 30a, 30b may include an existing mobility cane 32 that has been retrofit with user computing device 36a, 36b. In this way, a user may not necessarily need to purchase a new white cane device 30a, 30b in order to present an accessible user interface representing one or more account access functions of an ATM as described herein.

User computing devices 36a, 36b illustrated in FIGS. 2A and 2B include both input interfaces and output interfaces. In the example of FIG. 2A, user computing device 36a includes a keypad 42. Keypad 42 may include a plurality of soft buttons (e.g., keys), a plurality of hard buttons, or any other type of buttons. The shape and size of the buttons of keypad 42 may be any suitable shape or size for particular needs. Moreover, keypad 42 may include any number or layout of buttons.

Keypad 42 may have any suitable configuration. For example, keypad 42 may include a numerical keypad, yes and/or no selection buttons, an alphabetical keypad, account access function selection buttons, an emergency button, a send card button, an application access button, a volume control button, or the like. Thus, keypad 42 may enable a user to access an application (e.g., an application enabling white cane device 30a to operate in accordance with the techniques of the disclosure), send an account number to an ATM, input a PIN, select one or more account access functions, input information relating to the one or more account access functions, send a silent alarm, control a volume of an auditory output of white cane 30a, or combinations thereof.

In the example of FIG. 2B, user computing device 36b includes a touch screen 44. Touch screen 44 may enable the user to access an application, send an account number to an ATM, input a PIN, select one or more account access functions, input information relating to the one or more account access functions, send a silent alarm, control a volume of an auditory output of white cane 30b, or combinations thereof, similar to keypad 42. Touch screen 44 may include any suitable configuration. For example, touch screen 44 may include a pressure sensitive touch screen, a capacitive touch screen, or any other screen capable of accepting user input from a user. In some cases, touch screen 44 includes a presence-sensitive display that receives input from a user using capacitive, inductive, and/or optical detection at or near the presence sensitive display.

Additionally, or alternatively, user computing devices 36a, 36b may include a microphone as an input interface device. User computing devices 36a, 36b may include one or any combination of buttons, keypads, touch screens, and/or microphones. In other examples, user computing devices 36a, 36b may include a different input interface device in addition to, or as an alternative to, a keypad, buttons, a touch screen, and/or a microphone.

In some cases, touch screen 44 (or any other input interfaces) may not include a visual output, or may not include a detailed visual output. For example, because the user of white cane device 30b is likely a visually impaired user, it may not be useful for touch screen 44 to display a visual output to the user. Thus, user computing devices 36a, 36b include one or more output interfaces to present an auditory output, a tactile output, or both to the user. For example, user interface devices 36a, 36b may include a speaker 40, a headphone jack 38, a vibration motor, and/or an actuator. Moreover, in some cases, user computing devices 36a, 36b may be configured to may be able to connect to an output device, such as headphones or an external speaker, using a communication protocol such as Bluetooth®.

In this way, the output interfaces of user computing devices 36a, 36b may be able to provide feedback, instructions, or the like to the user. For example, user computing devices 36a, 36b may provide feedback indicating a selection made by the user, confirmation of a connection to an ATM, confirmation of an authentication step, or the like. As one example, an output interface of user computing devices 36a, 36b may indicate what was input for a PIN. Additionally, or alternatively, an output interface may provide instructions to the user, such as, for example, instructions regarding the layout of the ATM to help the user more easily find a cash dispenser or another component of the ATM. As another example, an output interface may provide directions relating to the techniques described herein, such as, directions to contact an edge of a cash dispenser of an ATM so that biometric information can be obtained for re-authentication of the user. In other examples, an output interface of user computing devices 36a, 36b may provide additional or alternative feedback and/or instructions to the user.

In some cases, a type or setting of an output of user computing devices 36a, 36b may depend on an input received by user computing devices 36a, 36b. For example, receipt of a PIN using an input interface of user computing devices 36a, 36b may reduce a volume of a speech output, or even prevent a speech output altogether (e.g., in the case in which speaker 40 is used for the speech output and headphones are not connected to headphone jack 38). In this way, another person may not be able to hear the feedback provided by white cane devices 30a, 30b indicating the PIN entered by the user to access his or her financial account. Rather, the volume may be reduced such that the user has to bring speaker 40 closer to his or her ear to hear the repeated PIN or the PIN may not be provided using a speech output at all through speaker 40. As another example, the PIN may only be repeated audibly in examples in which headphones are connected to headphone jack 38.

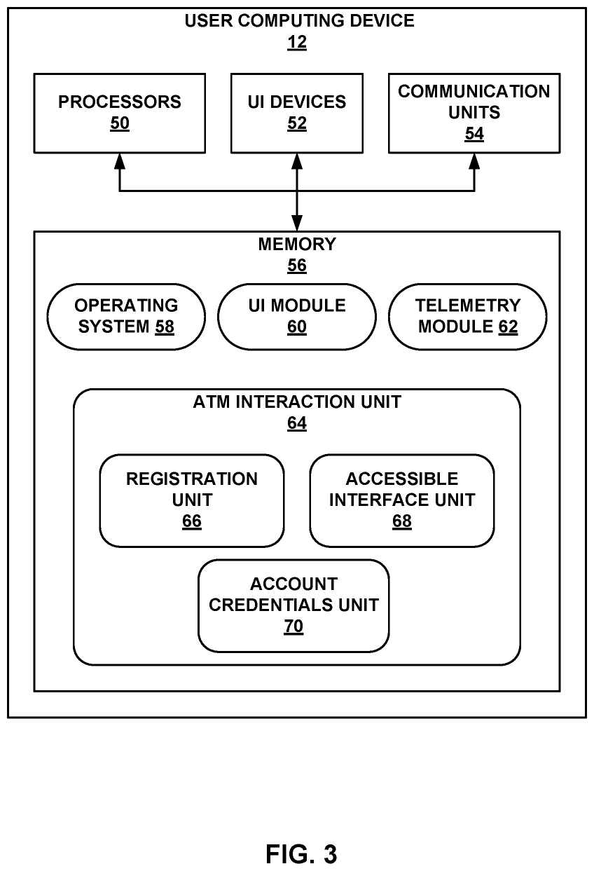

FIG. 3 is a block diagram illustrating an example user computing device 12 configured to present an accessible user interface of one or more account access functions of an ATM, in accordance with the techniques of this disclosure. The architecture of user computing device 12 illustrated in FIG. 3 is shown for exemplary purposes only and user computing device 12 should not be limited to this architecture. In other examples, user computing device 12 may be configured in a variety of ways.

As shown in the example of FIG. 3, user computing device 12 includes one or more processors 50, one or more user interface (UI) devices 52, one or more communication units 54, and one or more memory units 56. Memory 56 of user computing device 12 includes operating system 58, UI module 60, telemetry module 62, and ATM interaction unit 64, which are executable by processors 50. Each of the components, units, or modules of user computing device 12 are coupled (physically, communicatively, and/or operatively) using communication channels for inter-component communications. In some examples, the communication channels may include a system bus, a network connection, an inter-process communication data structure, or any other method for communicating data.

Processors 50, in one example, may include one or more processors that are configured to implement functionality and/or process instructions for execution within user computing device 12. For example, processors 50 may be capable of processing instructions stored by memory 56. Processors 50 may include, for example, microprocessors, DSPs, ASICs, FPGAs, or equivalent discrete or integrated logic circuitry, or a combination of any of the foregoing devices or circuitry.

Memory 56 may be configured to store information within user computing device 12 during operation. Memory 56 may include a computer-readable storage medium or computer-readable storage device. In some examples, memory 56 includes one or more of a short-term memory or a long-term memory. Memory 56 may include, for example, RAM, DRAM, SRAM, magnetic discs, optical discs, flash memories, or forms of EPROM, or EEPROM. In some examples, memory 56 is used to store program instructions for execution by processors 50. Memory 56 may be used by software or applications running on user computing device 12 (e.g., ATM interaction unit 64) to temporarily store information during program execution.

User computing device 12 may utilize communication units 54 to communicate with external devices, e.g., ATM 14 of FIG. 1, via one or more networks or via wireless signals. Communication units 54 may be network interfaces, such as Ethernet interfaces, optical transceivers, radio frequency (RF) transceivers, or any other type of devices that can send and receive information. Other examples of interfaces may include Wi-Fi, NFC, or Bluetooth® radios.

UI devices 52 may be configured to operate as both input devices and output devices. For example, UI devices 52 may be configured to receive tactile, audio, or visual input from a user of user computing device 12. In addition to receiving input from a user, UI devices 52 may be configured to provide output to a user using tactile, audio, or video stimuli. In one example, UI devices 52 may input and output interfaces such as a keypad, a touch screen, a microphone, a speaker, a headphone jack, a vibration motor, and/or an actuator. UI devices 52 may include a presence-sensitive display that receives input from a user using capacitive, inductive, and/or optical detection at or near the presence sensitive display (e.g., similar to touch screen of FIG. 2B). Other examples of UI devices 52 include any other type of device for detecting a command from a user, a sound card, a video graphics adapter card, or any other type of device for converting a signal into an appropriate form understandable to humans or machines. In some examples, UI devices 52 include devices to provide output to a visually impaired user (e.g., intelligible auditory and/or tactile output).

Operating system 58 controls the operation of components of user computing device 12. For example, operating system 58, in one example, facilitates the communication of UI module 60, telemetry module 62, and ATM interaction unit 64 with processors 50, UI devices 52, communication units 54, and memory 56. UI module 60, telemetry module 62, and ATM interaction unit 64 may each include program instructions and/or data stored in memory 56 that are executable by processors 50. For example, ATM interaction unit 64 may include instructions that cause user computing device 12 to perform one or more of the techniques described herein.

UI module 60 may be software and/or hardware configured to interact with one or more UI devices 52. For example, UI module 60 may generate audio or tactile output, such as speech or haptic output, to be transmit to a user through one or more UI devices 52. In some examples, UI module 60 may process an input after receiving it from one of UI devices 52, or UI module 60 may process an output prior to sending it to one of UI devices 52.

Telemetry module 62 may be software and/or hardware configured to interact with one or more communication units 54. Telemetry module 62 may generate and/or process data packets sent or received using communication units 54. In some examples, telemetry module 62 may process one or more data packets after receiving it from one of communication units 54. In other examples, telemetry module 62 may generate one or more data packets or process one or more data packets prior sending it via communication units 54.

User computing device 12 may include additional components that, for clarity, are not shown in FIG. 3. For example, user computing device 12 may include a battery to provide power to the components of user computing device 12. Similarly, the components of user computing device 12 shown in FIG. 3 may not be necessary in every example of user computing device 12.

In the example illustrated in FIG. 3, ATM interaction unit 64 includes registration unit 66, accessible interface unit 68, and account credentials unit 70. Registration unit 66 may enable a user to register with user computing device 12 with a financial institution (e.g., financial institution 20 of FIG. 1). For example, registration unit 66 may be configured to request a unique identifier, a one time passcode, and/or a passcode card from a server (e.g., server 16 of FIG. 1). The unique identifier, one time passcode, and/or passcode card information may be input using user computing device 12 and/or an ATM (e.g., ATM 14 of FIG. 1) to establish a communication session between user computing device 12 and the ATM for a first time.

In some examples, ATM interaction unit 64 may be in the form of an application on user computing device 12. Upon download or installation of the application, registration unit 66 may request the unique identifier, one time passcode, and/or passcode card from the server. In some examples, registration unit 66 may receive the requested information, such as the unique identifier, one time passcode, or passcode card information, and store the received unique identifier, one time passcode, or passcode card information in memory 56. Upon detection of user computing device 12 within a predetermined range of an ATM and/or the user accessing the application using UI devices 52, registration unit 66 may send the stored unique identifier, one time passcode, or passcode card information to the ATM for authentication. In some examples, registration unit 66 may receive the unique identifier, one time passcode, or passcode card information from a user. In other examples, registration unit 66 may access the unique identifier, one time passcode, or passcode card information stored in memory 56. In some cases, registration unit 66 may only send the information to the ATM to establish a first communication session with the ATM or with a first ATM associated with a financial institution. For example, after the initial connection with the ATM or an ATM associated with the financial institution, the ATM or financial institution network may remember user computing device 12 and automatically establish a communication session with user computing device 12 upon detecting user computing device 12 and/or the user accessing the application.

Additionally, or alternatively, registration unit 66 may request and receive information from the user of user computing device 12. For example, registration unit 66 may be configured to receive biometric information of the user, such as fingerprint information, facial recognition information, or the like. Registration unit 66 may receive the biometric information from UI devices 52 and send the received biometric information to the server to associate the received biometric information with user computing device 12 and/or the user of user computing device 12.

In some examples, registration unit 66 may also determine if user computing device 12 includes a white cane device configured to support the accessible user interface as described herein. If registration unit 66 determines that user computing device 12 is a white cane device configured to support the accessible user interface, registration unit 66 may send information indicating that user computing device 12 is a white cane device to server 16.

Accessible interface unit 68 is configured to receive data representative of an accessible user interface of one or more account access functions of an ATM. The data representative of the accessible user interface may be different than a user interface presented by the ATM. For example, the accessible user interface may include an auditory output and/or a tactile output, and the user interface presented by the ATM for the same one or more account access functions may include a visual output. Thus, the data representative of the accessible user interface may include data representative of an auditory output, a tactile output, or both, such as, for example, a speech output and/or a haptic output.

In some examples, accessible interface unit 68 is configured to modify data representative of a user interface received from an ATM. For example, accessible interface unit 68 may be able to make modifications to the received data such that the data representative of the accessible user interface is compatible with user interface 12. In other examples, accessible interface unit 68 may be configured to create a set of data representative of the accessible user interface from a set of data representative of a user interface presented by the ATM for the same one or more account access functions. For instance, accessible interface unit 68 may receive a first set of data representative of the user interface device presented by the ATM for one or more account access functions (e.g., a user interface including a visual output) and may create a second set of data representative of the accessible user interface for the same one or more account access functions (e.g., an accessible user interface including an auditory and/or tactile output).

Accessible interface unit 68 presents the accessible user interface using UI devices 52. Accessible interface unit 68 may receive one or more inputs from a user using UI devices 52 relating to operation of the ATM using the accessible user interface, such as selection of an account access function, authentication of account credentials of the user, or other functions as described herein. In some examples, accessible interface unit 68 may send one or more of the received inputs to the ATM. For example, accessible interface unit 68 may send a receive selection of at least one account access function to the ATM. Moreover, accessible interface unit 68 may be configured to provide feedback, instructions, confirmation, or status updates to the user via UI devices 52.

Account credentials unit 70 may store account credentials for one or more financial accounts of the user of user computing device 12. The account credentials may be used to perform an account access function using an ATM. Each of the account credentials for the financial accounts of the user may correspond to a financial account associated with a financial institution. In some cases, the user may manually input the account credentials of the one or more financial accounts for storage by account credentials unit 70. In other examples, account credentials unit may be configured to receive the account credentials from a card of the user. For example, a user may be able to swipe, insert, or transmit (e.g., using NFC, RFID, or the like) the account credentials to account credentials unit 70 using a card including at least an account number.

In some examples, account credentials unit 70 may only store a portion of the user's account credentials. For example, account credentials unit 70 may store one or more account numbers of the user, but may not store PINs associated with the account numbers. In this way, a user may need to enter the PIN each time he or she attempts to access a financial account such that someone cannot access the user's account from user computing device 12 without also knowing the PIN associated with the account number.

Account credentials unit 70 may send the account number of the user to an ATM upon a communication session being established between user computing 12 and the ATM. In some examples, account credentials unit 70 may automatically send the account number to the ATM upon establishment of the communication session. In other examples, a user may need to provide input to user computing device 12 indicating that account credentials unit 70 should send the account number to the ATM.

In some cases, account credentials unit 70 may not store the account credentials, but may receive the account credentials when the account credentials are to be sent to the ATM for authentication. For example, a user may swipe, insert, or transmit (e.g., using NFC, RFID, or the like) the account credentials to account credentials unit 70 using a card including at least an account number each time the account credentials are to be sent to the ATM. In some examples, account credentials unit 70 may alert accessible interface unit 68 to prompt the user to enter such account credentials via the accessible user interface.

Once account credentials unit 70 receives at least the account number, account credentials unit 70 may send the account number to the ATM. Account credentials unit 70 may then alert accessible interface unit 68 to prompt the user to enter a PIN associated with the account number sent to the ATM and send the received PIN to the ATM for authentication of the user.

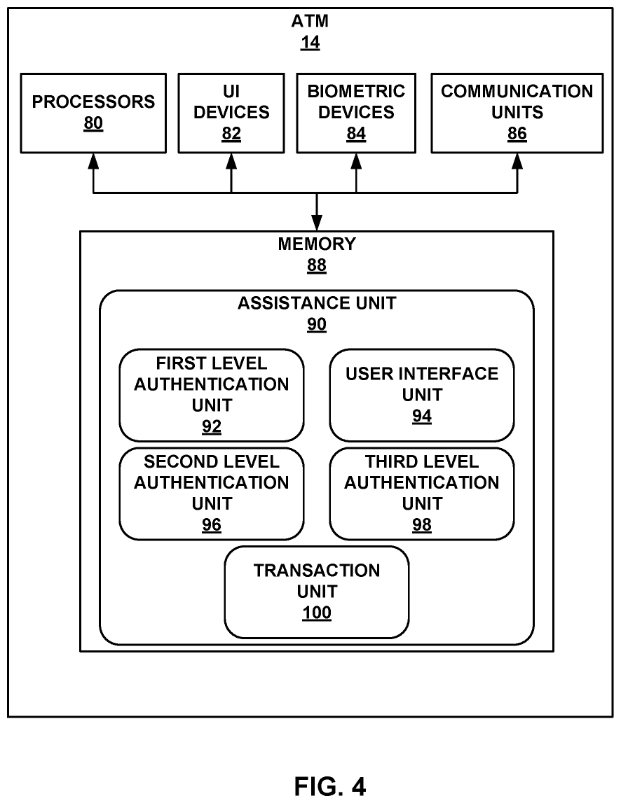

FIG. 4 is a block diagram illustrating an example ATM 14, in accordance with aspects of the disclosure. The architecture of ATM 14 illustrated in FIG. 4 is shown for exemplary purposes only, and ATM 14 should not be limited to this architecture. In some examples, ATM 14 may include additional components that, for clarity, are not shown in FIG. 4. In other examples, ATM 14 may be configured in a variety of ways.

As shown in the example of FIG. 4, ATM 14 includes one or more processors 80, one or more UI devices 82, one or more biometric devices 84, one or more communication units 86, and one or more memory units 88. ATM 14 also includes assistance unit 90 and transaction unit 100 each of which may be implemented as program instructions and/or data stored in memory 84 and executable by processors 80 or implemented as one or more hardware units or devices of ATM 14. In some examples, memory 88 of ATM 14 may also store an operating system executable by processors 80. The operating system stored in memory 88 may control the operation of components of ATM 14. The components, units or modules of ATM 14 are coupled (physically, communicatively, and/or operatively) using communication channels for inter-component communications. In some examples, the communication channels may include a system bus, an inter-process communication data structure, or any other method for communicating data.

Processors 80, in one example, may include one or more processors that are configured to implement functionality and/or process instructions for execution within ATM 14. For example, processors 80 may be capable of processing instructions stored by memory 84. Processors 80 may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

Memory 88 may be configured to store information within ATM 14 during operation. Memory 88 may include a computer-readable storage medium. In some examples, memory 88 includes one or more of a short-term memory or a long-term memory. Memory 88 may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, memory 88 is used to store program instructions for execution by processors 80. Memory 88 may be used by software running on ATM 14 (e.g., assistance unit 90) to temporarily store information during program execution.

ATM 14 may utilize communication units 86 to communicate with external devices via one or more networks, e.g., network 18 from FIG. 1, or via wireless signals. communication units 86 may be network interfaces, such as Ethernet interfaces, optical transceivers, radio frequency (RF) transceivers, or any other type of devices that can send and receive information. Other examples of interfaces may include Wi-Fi, NFC, or Bluetooth® radios. In some examples, ATM 14 utilizes communication units 86 to wirelessly communicate with an external device, such as user computing device 12 from FIG. 1.

ATM 14 may include UI devices 82 to communicate with some users of ATM 14. UI devices 82 may be configured to operate as both input devices and output devices. For example, UI devices 82 may be configured to receive tactile, audio, or visual input from a user of ATM 14. In addition to receiving input from a user, UI devices 82 may be configured to provide output to a user using tactile, audio, or video stimuli. In one example, UI devices 82 may be configured to output content for display, e.g., a GUI, in accordance with a user interface unit stored in memory 88. In some such examples, UI devices 82 may include a presence-sensitive display that displays a GUI and receives input from a user using capacitive, inductive, and/or optical detection at or near the presence sensitive display. Other examples of UI devices 82 include a keypad, touchpad, a voice responsive system, video camera, microphone or any other type of device for detecting a command from a user, or a sound card, a video graphics adapter card, or any other type of device for converting a signal into an appropriate form understandable to humans or machines. Additional examples of UI devices 82 include a speaker, a CRT monitor, a LCD, OLED, or any other type of device that can generate intelligible output to a user.

ATM 14 includes one or more biometric devices 84 configured to obtain biometric information from a user. For example, biometric devices 84 may include fingerprint scanners, retina scanners, facial recognition devices, or other biometric devices. As one example, ATM 14 may include one or more fingerprint scanners around a cash dispenser of ATM 14. The biometric information obtained by biometric devices 84 may be used to register a user, authenticate a user, and/or re-authenticate a user.

ATM 14 may include additional components that, for clarity, are not shown in FIG. 4. Similarly, the components of ATM 14 shown in FIG. 4 may not be necessary in every example of ATM 14.

Memory 88 of ATM 14 includes assistance unit 90 configured to perform up to a three-level authentication scheme of a user and provide data representative of an accessible user interface to a user computing device, such as user computing device 12 of FIG. 1. Assistance unit 90 includes first level authentication unit 92, user interface unit 94, second level authentication unit 96, third level authentication unit 98, and transaction unit 100. First level authentication unit 92 is configured to establish a communication session between ATM 14 and a user computing device such that the user computing device can present an accessible user interface. In some examples, first level authentication unit 92 may receive an indication to establish a communication session from a user computing device. Additionally, or alternatively, first level authentication unit 92 may detect a user computing device when the user computing device is within a predetermined range from ATM 14, and may initiate a communication session between ATM 14 and the user computing device based on the detection.

In some cases, first level authentication unit 92 may establish the communication session between ATM 14 and the user computing device by determining communication capabilities of user computing device and establishing a communication session with the user computing device based on the identified communication capability. As one example, first level authentication unit 92 may determine that the user computing device has Bluetooth® capabilities. First level authentication unit 92 may than establish the communication session with the user computing device using Bluetooth® and push data representative of an accessible user interface to the user computing device.

In other examples, first level authentication unit 92 may receive limited information from the user computing device prior to establishing the communication session between ATM 14 and user computing device, and may authenticate the user computing device based on the limited information. For example, first level authentication unit 92 may receive a unique identifier, a one time passcode, passcode card information, facial recognition information from user computing device and/or UI devices 82 of ATM 14. First level authentication unit 92 may send the received unique identifier, one time passcode, passcode card information, facial recognition information to a server for authentication of the user computing device. First level authentication unit 92 may receive registration information from the server indicating whether the user computing device is registered (e.g., the received information was both associated with the user computing device and correct based on stored information associated with the user computing device). In some such cases, first level authentication unit 92 may determine that the user computing device is a white cane device configured to support the accessible user interface.

In some cases, first level authentication unit 92 may only send information to determine if the user computing device is registered to establish a communication session with the user computing device for a first time. For example, after a communication session has been established between ATM 14 and the user computing device one or more times, or if the user computing device has previously connected to another ATM associated with the financial institution of ATM 14, first level authentication unit 92 may automatically establish a communication session between ATM 14 and the user computing device upon receiving an indication to establish a communication session from the user computing device and/or detected the user computing device within the predetermined range of ATM 14. Thus, in some examples, first level authentication unit 92 may operate without input of a user and/or without exchanging information with a sever.

Upon first level authentication unit 92 establishing the communication session between ATM 14 and the user computing device, user interface unit 94 may send data representative of an accessible user interface to the user computing device. For example, user interface unit 94 may send data representative of an auditory output and/or a tactile output relating to one or more account access functions of ATM 14. The data representative of the accessible user interface may be different than data representative of a user interface presented by ATM 14, which may include a visual output of the same one or more account access functions. In examples in which first level authentication unit 92 determines that the user computing device includes a white cane device configured to support the accessible user interface, user interface unit 94 may automatically send the data representative of the accessible user interface to the user computing device.

In some cases, ATM 14 may already include data representative of an accessible user interface. In this way, the functionality of ATM 14 described herein may be able to be retrofit on existed ATMs without new data representative of an accessible interface needing to be created. In other examples, user interface unit 94 may create the data representative of the accessible user interface of the one or more account access functions based on data representative of a user interface presented by ATM 14 for the same one or more account access functions. In yet another example, user interface unit 94 may send a set of data representative of a user interface presented by ATM 14 to the user computing device, and the user computing device may create the accessible user interface based on the set of data.

Second level authentication unit 96 is configured to authenticate account credentials of a user. For example, second level authentication unit 96 may receive an account number and a PIN. In some examples, second level authentication unit 96 sends the received account number and PIN to a server to comparison to a stored PIN associated with the received account number. Second level authentication unit 96 may authenticate the user based on the comparison (e.g., if the received PIN and the stored PIN are the same, ATM 14 may be able to perform one or more account access functions).

After the account credentials are authenticated, transaction unit 100 may receive a selection of an account access function from the user computing device. For example, transaction unit 100 may receive selection of a withdrawal transaction, a fund deposit, a fund transfer, an account balance check, or another function related to the financial account of the user, and any details that pertain to the selected account access function (e.g., an amount for a withdrawal transaction or a fund deposit). Transaction unit 100 may configure ATM 14 to perform the selected one or more account access functions. In some examples, transaction unit 100 may communicate with a server to determine if a user has sufficient funds to perform a transaction based on the account credentials of the user.

If the selected one or more account access functions includes a withdrawal transaction, transaction unit 100 may alert third level authentication unit 98 to obtain biometric information from the user so that the user can be re-authenticated prior to the funds being dispensed to the user. In some cases, third level authentication unit 98 may instruct user interface unit 94 to send data representative of directions for the user, a description of the layout of ATM 14, or the like to help the user easily locate biometric devices 84. Third level authentication unit 98 may then receive the biometric information of the user from biometric devices 84. Third level authentication unit 98 may send the received biometric information to a server for re-authentication of the user.

If the user was successfully re-authenticated, third level authentication unit 98 may notify transaction unit 100 to dispense the funds to the user. In some examples, third level authentication unit 98 may only authorize transaction unit 100 to dispense the funds if third level authentication unit 98 determines the user is maintaining contact with biometric devices 84 and the user has been successfully re-authenticated. In this way, a bad actor may be less likely to steal from or otherwise compromise the user performing a withdrawal transaction using ATM 14.

If at any time one of first level authentication unit 92, second level authentication unit 96, or third level authentication unit 98 cannot authenticate the user and/or the user computing device, first level authentication unit 92, second level authentication unit 96, and/or third level authentication unit 98 may prompt user interface unit 94 to alert the user that he or she could not be authenticated and terminate the communication session between ATM 14 and the user computing device.

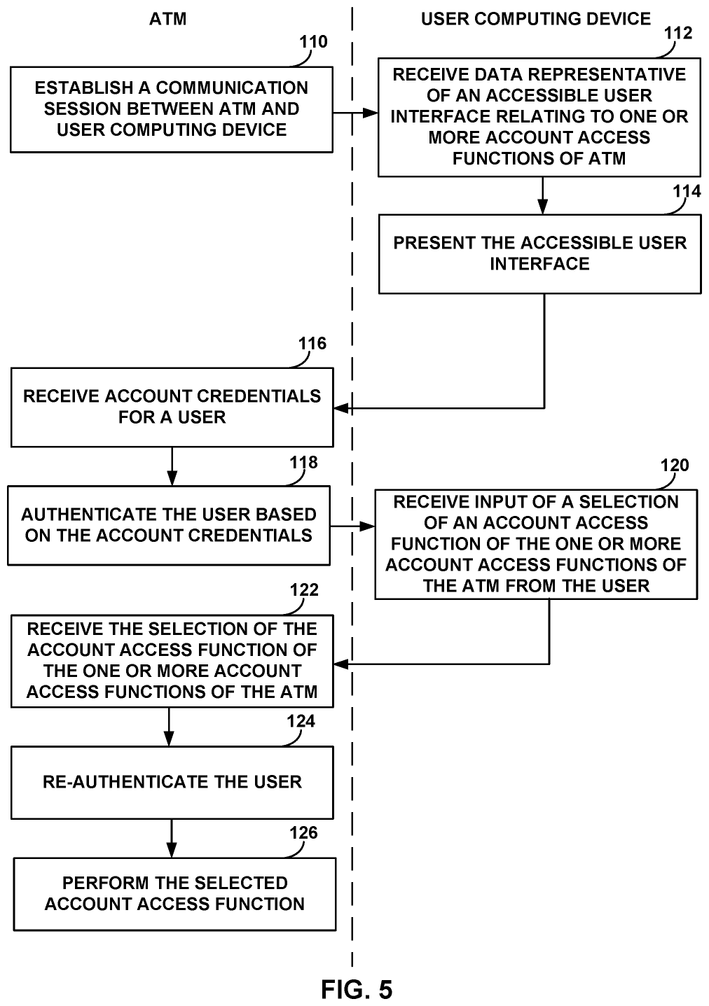

FIG. 5 is a flow diagram illustrating an example technique to perform one or more account access functions on an ATM using an accessible user interface presented by a user computing device, in accordance with aspects of the disclosure. The example technique of FIG. 5 will be described with respect to system 10 of FIG. 1.

ATM 14 establishes a communication session between ATM 14 and user computing device 12 (110). In some examples, ATM 14 may detect user computing device 12 within a predetermined range from ATM 14 and may establish the communication session based on the detection. In some such examples, prior to establishing the communication session between ATM 14 and user computing device 12, ATM 14 may authenticate user computing device 12 as a registered user computing device, such as based on a remembered user computing device 12 and/or verifying that user computing device 12 is registered with financial institution 20 through server 16. In some such examples, ATM 14 may further determine that user computing device 12 includes a white cane device configured to support the accessible user interface, and may automatically send data representative of the accessible user interface to user computing device 12. In some cases, determination that user computing device 12 is a white cane device may indicate that the user is a visually impaired user that may want to operate ATM 14 using the accessible user interface presented by user computing device 12. In this way, ATM 14 automatically sending user computing device 12 the data representative of the accessible user interface may require less input or steps to be taken by user.

In examples in which ATM 14 and user computing device 12 have been previously connected, ATM 14 may remember user computing device 12 and automatically establish the communication session. In other examples, such as if ATM 14 and user computing device have not previously been connected, ATM 14 may establish the communication session based on communication capabilities of user computing device 12 or based on a limited set of information available from user computing device 12. As one example, ATM 14 may receive a unique identifier, a one time passcode, passcode card information, and/or facial recognition data and send the received information to server 16 for authentication. If server 16 determines that the user and/or user computing device 12 is associated with the received unique identifier, one time passcode, passcode card information, and/or facial recognition information, ATM 14 may establish the communication session.

In some cases, ATM 14 and user computing device 12 may establish a PKI secure communication session over a network, such as a PAN or a WAN, e.g., network 18. ATM 14 and user computing device 12 may further exchange a symmetric session key to encrypt messages exchanged during the communication session. Such examples may establish a secure communication channel between ATM 14 and user computing device 12.

After the communication session is established, user computing device 12 receives data representative of an accessible user interface relating to one or more account access functions of ATM 14 (112). The data representative of the accessible user interface may include data representative of an auditory and/or a tactile output of the one or more account access functions. In some examples, ATM 14 may create the data representative of the accessible user interface including the auditory and/or tactile output of the one or more account access functions based on data representative of the same one or more account access functions for presentation by ATM 14 via a visual output. User computing device 12 presents the accessible user interface (114). In some cases, user computing device 12 presents at least one of an auditory output or a tactile output representing at least one account access function of the one or more account access functions of ATM 14. The accessible user interface may be different than a user interface presented by ATM 14 for the same one or more account access functions of ATM 14.

ATM 14 receives account credentials for the user of user computing device 12 (116). The account credentials may include an account number and a PIN number. In some examples, a user may input an account number and a PIN using the accessible user interface presented by user computing device 12. As another example, user computing device 12 may send the account number to ATM 14 and the user may input the PIN using the accessible user interface presented by user computing device 12. As yet another example, user computing device 12 may be configured to allow a user to swipe, insert, or transmit (e.g., using NFC, RFID, or the like) a card associated with the account number of the user and the user may input the PIN using the accessible user interface presented by user computing device 12.

ATM 14 authenticates the user based on the account credentials (118). In some examples, ATM 14 compares the received PIN to a stored PIN associated with the account number and verifies the received PIN based on the comparison. The stored PIN may be stored at server 16. In other examples, ATM 14 may send the received PIN to server 16 and server 16 may compare the received PIN to the stored PIN.

User computing device 12 may receive input of a selection of an account access function of the one or more account access functions of ATM 14 from the user (120) and sent the received selection to ATM 14. ATM 14 receives the selection of the account access function of the one or more account access functions from user computing device 12 (122). The selection of the account access function may include a withdrawal transaction, a fund deposit, a fund transfer, an account balance check, or another function related to the financial account of the user, and any details that pertain to the selected account access function (e.g., an amount for a withdrawal transaction or a fund deposit).

In some examples, such as in the case in which the selected account access function includes a withdrawal transaction, ATM 14 may optionally re-authenticate the user (124). For example, ATM 14 may receive biometric information from the user, such as from a biometric device near a cash dispenser of ATM 14. ATM 14 may then re-authenticate the user based on the biometric information. If the user was successfully re-authenticated, or if ATM 14 did not re-authenticate the user, ATM 14 performs the selected account access function (126). For instance, ATM 14 may dispense the funds for the withdrawal transaction after the user was successfully re-authenticated.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a mobile computing device, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1: A method comprising:
detecting, by an automatic teller machine (ATM) associated with a financial institution, that a user computing device is within a predetermined range from the ATM;
authenticating, by the ATM, the user computing device as a registered computing device with the financial institution;
based on authentication of the user computing device as the registered computing device, establishing a communication session between the user computing device and the ATM;
upon establishment of the communication session, sending, by the ATM, data representative of the accessible user interface of the ATM for presentation by the user computing device, wherein the accessible user interface presented by the user computing device comprises at least one of an auditory output or a tactile output representing at least one account access function of one or more account access functions of the ATM, which is different than a user interface presented by the ATM that comprises a visual output representing the same at least one account access function of the one or more account access functions of the ATM;
receiving, by the ATM via the accessible user interface presented by the user computing device, account credentials for a user of the user computing device;
authenticating, by the ATM, the user of the user computing device based on the account credentials;
receiving, by the ATM via the accessible user interface presented by the user computing device, a selection of the at least one account access function of the one or more account access functions of the ATM; and
performing, by the ATM, the selected at least one account access function.

2. (canceled)

3. (canceled)

4: The method of claim 1, wherein establishing the communication session between the user computing device and the ATM comprises:
establishing, between the user computing device and the ATM, a public key infrastructure (PKI) secure communication session over a network; and
sending, from the ATM and to the user computing device, a symmetric session key to encrypt messages exchanged during the communication session.

5: The method of claim 1, wherein receiving the selection of the at least one account access function of the one or more account access functions of the ATM comprises receiving the selection of a withdrawal transaction, the method comprising:
receiving, by the ATM, biometric information of the user of the user computing device;
re-authenticating, by the ATM, the user of the user computing device based on the biometric information; and
dispensing, by the ATM and based on the re-authentication of the user, funds for the withdrawal transaction.

6: The method of claim 1, further comprising:
based on authentication of the user computing device as the registered computing device, determining, by the ATM, that the user computing device comprises a white cane device configured to support the accessible user interface of the ATM.

7: The method of claim 1, wherein receiving the account credentials for the user comprises at least one of:
receiving, by the ATM via the accessible user interface presented by the user computing device, an account number and a personal identification number (PIN) from the user;
receiving, by the ATM via the accessible user interface presented by the user computing device, at least the PIN from the user; or
determining, by the ATM via the accessible user interface presented by the user computing device, an account number from a card of the user and the PIN from the user.

8: The method of claim 7, wherein authenticating the user of the user computing device comprises:
comparing, by the ATM, the received PIN to a stored PIN associated with the account number, wherein the stored PIN for the account number is stored at a server of the financial institution; and
verifying, by the ATM, the received PIN based on the comparison.

9: The method of claim 1, further comprising registering the user computing device with the ATM, wherein registering the user computing device comprises:
in response to detecting that the user computing device is within the predetermined range from the ATM, receiving, by the ATM, registration information;
comparing, by the ATM, the received registration information to stored registration information associated with the user computing device, wherein the stored registration information for the user computing device is stored at a server of the financial institution; and
establishing, based on the comparison, the communication session between the user computing device and the ATM for a first time.

10: The method of claim 1, wherein the data representative of the accessible user interface comprises a first set of data comprising information relating to the at least one account access function of the one or more account access functions of the ATM for presentation by the user computing device via the at least one of the auditory output or the tactile output, the method further comprising creating, by the ATM, the first set of data based on a second set of data comprising information relating to the same at least one account access function of the one or more account access functions of the ATM for presentation by the ATM via the visual output.

11: An automatic teller machine (ATM) associated with a financial institution, the ATM comprising:
a memory; and
one or more processors in communication with the memory, the one or more processors configured to:
detect that a user computing device is within a predetermined range from the ATM;
authenticate the user computing device as a registered computing device with the financial institution;
based on authentication of the user computing device as the registered computing device, establish a communication session between the user computing device and the ATM;
upon establishment of the communication session, send data representative of the accessible user interface of the ATM for presentation by the user computing device, wherein the accessible user interface presented by the user computing device comprises at least one of an auditory output or a tactile output representing at least one account access function of one or more account access functions of the ATM, which is different than a user interface presented by the ATM that comprises a visual output representing the same at least one account access function of the one or more account access functions of the ATM;
receive, via the accessible user interface presented by the user computing device, account credentials for a user of the user computing device,
authenticate the user of the user computing device based on the account credentials,
receive, via the accessible user interface presented by the user computing device, a selection of the at least one account access function of the one or more account access functions of the ATM, and
perform the selected at least one account access function.

12. (canceled)

13. (canceled)

14: The ATM of claim 11, wherein to establish the communication session between the user computing device and the ATM, the one or more processors are configured to:
establish a public key infrastructure (PKI) secure communication session with the user computing device over a network; and
send, to the user computing device, a symmetric session key to encrypt messages exchanged during the communication session.

15: The ATM of claim 11, wherein the selection of the at least one account access function of the one or more account access functions of the ATM comprises a withdrawal transaction, and wherein the one or more processors are configured to:
receive biometric information of the user of the user computing device;
re-authenticate the user of the user computing device based on the biometric information; and
dispense, based on the re-authentication of the user, funds for the withdrawal transaction.

16: The ATM of claim 11, wherein the one or more processors are configured to:
based on authentication of the user computing device as the registered computing device, determine that the user computing device comprises a white cane device configured to support the accessible user interface of the ATM.

17: The ATM of claim 11, wherein, to receive the account credentials for the user, the one or more processors are configured to at least one of:
receive, via the accessible user interface presented by the user computing device, an account number and a personal identification number (PIN) from the user;
receive, via the accessible user interface presented by the user computing device, at least the PIN from the user; or
determine, via the accessible user interface presented by the user computing device, the account number from a card of the user and the PIN from the user.

18: The ATM of claim 17, wherein, to authenticate the user of the user computing device, the ATM is one or more processors are configured to:
compare the received PIN to a stored PIN associated with the account number, wherein the stored PIN for the account number is stored at a server of the financial institution; and
verify the received PIN based on the comparison.

19: The ATM of claim 11, wherein the one or more processors are configured to register the user computing device with the ATM, wherein, to register the user computing device, the one or more processors are further configured to:
in response to detecting that the user computing device is within the predetermined range from the ATM, receive registration information;
compare the received registration information to stored registration information associated with the user computing device, wherein the stored registration information for the user computing device is stored at a server of the financial institution; and
establish, based on the comparison, the communication session between the user computing device and the ATM for a first time.

20: The ATM of claim 11, wherein the data representative of the accessible user interface comprises a first set of data comprising information relating to the at least one account access function of the one or more account access functions of the ATM for presentation by the user computing device via the at least one of the auditory output or the tactile output, and wherein the one or more processors are further configured to create the first set of data based on a second set of data comprising information relating to the same at least one account access function of the one or more account access functions of the ATM for presentation by the ATM via the visual output.

21: A white cane device comprising:
a mobility cane; and
a user computing device connected to the mobility cane, the user computing device comprising a memory and one or more processors, wherein the one or more processors are configured to:
receive, from an automatic teller machine (ATM), a first set of data representative of a user interface relating to one or more account access functions of the ATM for presentation by the ATM via a visual output;
create, based on the first set of data, a second set of data representative of an accessible user interface relating to at least one account access function of the one or more account access functions of the ATM for presentation by the user computing device via at least one of an auditory output or a tactile output;
present the accessible user interface including the at least one of the auditory output or the tactile output representing the at least one account access function of the one or more account access functions of the ATM;
receive a selection of the at least one account access function of the one or more account access functions of the ATM via the accessible user interface; and
send, to the ATM, the selection of the at least one account access function.

22: The white cane device of claim 21, wherein the auditory output comprises a speech output and the tactile output comprises a haptic output.

23: The white cane device of claim 21, wherein the one or more processors are configured to provide feedback for presentation by the user computing device based on the selection of the at least one account access function, wherein the feedback comprises at least one of an auditory output or a tactile output.

24: The white cane device of claim 21, wherein the user computing device further comprises at least one output interface and at least one input interface;
wherein the at least one output interface comprises at least one of a speaker, a headphone jack, a vibration motor, or an actuator; and
wherein the at least one input interface comprises at least one of a keypad, a touch screen, or a microphone.
